(19) United States
(12) Patent Application Publication
(10) Pub. No.: US 2026/0303187 A1
(43) Pub. Date: Oct. 1, 2026

(54) BEAM MANAGEMENT

(71) Applicant: Nokia Technologies Oy, Espoo (FI)

(72) Inventors: Sajad REZAIE, Aalborg (DK); Carles NAVARRO, Aalborg (DK); Amir Mehdi AHMADIAN TEHRANI, Munich (DE); Keeth Saliya Jayasinghe LADDU, Espoo (FI)

(21) Appl. No.: 19/479,597

(22) PCT Filed: Mar. 19, 2024
(86) PCT No.: PCT/EP2024/057238

§ 371 Date: Oct. 28, 2025

(30) Foreign Application Priority Data
May 9, 2023 (FI) 20235517

(51) Int. Cl. H04B 7/06; H04B 17/318

(52) U.S. Cl. CPC H04B 7/06952; H04B 17/318

(57) ABSTRACT

Embodiments of the present disclosure relate to beam management. In an aspect, a device obtains at least one beam measurement. The device further determines, based on the beam measurement(s), measurement representation in a configurable direction space, wherein the measurement representation indicates a signal strength associated with the beam measurement(s) for a direction among a plurality of directions in the direction space. As such, the beam measurement(s) can be mapped into the direction space for efficient further processing of the beam measurement(s) for beam management. In some embodiments, beam measurements from various devices may be mapped into a common direction space, thereby allowing training a device-agnostic machine learning (ML) model and using the trained ML model for beam prediction for the various devices.

### FIELD

Various example embodiments relate to the field of telecommunication and in particular, to a device, a method, an apparatus and a computer readable storage medium for beam management.

### BACKGROUND

With development of communication technologies, beam management has evolved to support more advanced configurations such as multi beams reporting to enable multiple transmit receive points (multi-TRPs) and multi-panel configurations. However, with a larger number of beams supported by high-dimensional multiple-input-multiple-output (MIMO) arrays, beam measurements and feedback overhead radically increase. In addition, the time required for beam sweeping and beam establishment increases accordingly. Thus efficient beam management needs to be well studied in order to reduce the overhead and latency.

### SUMMARY

In general, example embodiments of the present disclosure provide a solution for beam management.

In a first aspect, there is provided a device. The device comprises at least one processor and at least one memory storing instructions that, when executed by the at least one processor, cause the device at least to: obtain at least one beam measurement; and determine, based on the at least one beam measurement, a measurement representation in a configurable direction space, wherein the measurement representation indicates a signal strength associated with the at least one beam measurement for a direction among a plurality of directions in the direction space.

In a second aspect, there is provided a method. The method comprises obtaining at least one beam measurement; and determining, based on the at least one beam measurement, a measurement representation in a configurable direction space, wherein the measurement representation indicates a signal strength associated with the at least one beam measurement for a direction among a plurality of directions in the direction space.

In a third aspect, there is provided an apparatus comprising: means for obtaining at least one beam measurement; and means for determining, based on the at least one beam measurement, a measurement representation in a configurable direction space, wherein the measurement representation indicates a signal strength associated with the at least one beam measurement for a direction among a plurality of directions in the direction space.

In a fourth aspect, there is provided a non-transitory computer readable medium comprising program instructions for causing an apparatus to perform at least the method according to any one of the above second aspect.

In a fifth aspect, there is provided a computer program comprising instructions, which, when executed by an apparatus, cause the apparatus at least to: obtain at least one beam measurement; and determine, based on the at least one beam measurement, a measurement representation in a configurable direction space, wherein the measurement representation indicates a signal strength associated with the at least one beam measurement for a direction among a plurality of directions in the direction space.

In a six aspect, there is provided a device comprising: obtaining circuitry configured to obtain at least one beam measurement; and determining circuitry configured to determine, based on the at least one beam measurement, a measurement representation in a configurable direction space, wherein the measurement representation indicates a signal strength associated with the at least one beam measurement for a direction among a plurality of directions in the direction space.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example framework in which embodiments of the present disclosure may be implemented;

FIG. 1B illustrates an example communication system in which embodiments of the present disclosure may be implemented;

FIG. 2 illustrates an example of a process for beam management according to some embodiments of the present disclosure;

FIG. 3 illustrates an example of a process for beam selection according to some embodiments of the present disclosure;

FIG. 4 illustrates an example of a direction space and example associations between beams and directions according to some embodiments of the present disclosure;

FIG. 5 illustrates an example of a process of determining antenna gain associated with the beam codebook for each direction in the direction space according to some embodiments of the present disclosure;

FIG. 6 illustrates an example of a process of mapping the beam measurements into the measurement representation in the direction space according to some embodiments of the present disclosure;

FIG. 7 illustrates an example of a process for a DL Rx beam prediction according to an embodiment of the present disclosure;

FIG. 8 illustrates another example of a process for a DL Rx beam prediction according to an embodiment of the present disclosure;

FIG. 9 illustrates examples of a process for beam pair prediction according to an embodiment of the present disclosure;

FIG. 10 illustrates an example of a process for a DL Tx-Rx beam pair prediction according to an embodiment of the present disclosure;

FIG. 11 illustrates another example of a process for a DL Tx-Rx beam pair prediction according to an embodiment of the present disclosure;

FIG. 12 illustrates a flowchart of a method implemented at a device according to some embodiments of the present disclosure;

FIG. 13 illustrates a simplified block diagram of an apparatus that is suitable for implementing embodiments of the present disclosure; and

FIG. 14 illustrates a block diagram of an example computer readable medium in accordance with some embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, efficient beam management needs to be well studied in order to reduce the overhead and latency. Conventionally, as defined in 3GPP TR 38.802, a gNB and UE may perform the following procedures P1, P2 and P3 for beam management (BM):

P1 provides beam sweeping implemented for the gNB to scan the coverage area by periodically transmitting synchronization signal block (SSBs) with wide angular beams. Conversely, the UE scans different SSBs to identify the best beam and corresponding time/frequency resources on which requesting access.

During P2, the gNB performs beam refinement by transmitting channel state information-reference signals (CSI-RSs) with narrow beams to identify a more precise direction towards the UE after establishing the wide beam in P1.

During P3, beam refinement is implemented at the UE side to scan a set of receiver (Rx) narrow beams while the gNB transmits CSI-RSs using the best beam identified in P2.

The procedures P1, P2 and P3 may be executed sequentially to establish the data transmission between the gNB and the UE. Moreover, in case of beam failure and recovery, the procedures P1, P2 and P3 may be fully repeated. In addition, the procedures P2 and P3 may be also periodically repeated for beam maintenance.

In Rel-18, artificial intelligence (AI)/machine learning (ML)-based beam management has been proposed and studied for overhead savings and latency reduction. It has been shown that ML algorithms enable predicting a serving beam for different UE locations and time instances without a need to measure the actual beam quality, thereby saving resources required for data transmission. On the other hand, beam scanning operations like those performed in P1, P2 and P3 are time inefficient and not scalable when the size of antenna arrays increases. ML algorithms can replace sequential beam scanning by recommending a reduced set of beams likely to contain the best beam index of the full scan.

Currently, in Rel-18 it has been agreed that use cases for AI/ML-based beam management may be directed to beam prediction in time and/or spatial domain and beam selection accuracy improvement. Specifically, it has been agreed that:

For AI/ML-based beam management, support BM-Case1 and BM-Case2 for characterization and baseline performance evaluations.
BM-Case1: Spatial-domain downlink (DL) beam prediction for Set A of beams based on measurement results of Set B of beams
BM-Case2: Temporal DL beam prediction for Set A of beams based on the historic measurement results of Set B of beams
FFS: details of BM-Case1 and BM-Case2; FFS: other sub use cases
   Note: For BM-Case1 and BM-Case2, Beams in Set A and Set B can be in the same Frequency Range.

Beam prediction in time domain may refer to a broad range of ML approaches that predict the next beam to use. These ML approaches may predict the best beam to use in successive time instances. Differently, spatial domain ML approaches infer the best beam in different spatial locations. In addition, the approaches considering improving beam selection accuracy look more to system performance aspects such as reliability and outage, targeting more specific applications.

Moreover, in Rel-18 it has been agreed that:

For the sub use case BM-Case1 and BM-Case2, further study the following alternatives for the predicted beams:
Alternative 1: DL transmitter (Tx) beam prediction
Alternative 2: DL Rx beam prediction
Alternative 3: Beam pair prediction (a beam pair consists of a DL Tx beam and a corresponding DL Rx beam)
Note1: DL Rx beam prediction may or may not have spec impact

However, although ML-based beam (pair) selection solutions have provided significant gains over traditional beam selection methods, most of the research and proposals in this area consider a UE-specific structure (if the ML model is obtained at gNB) or a gNB-specific structure (if the ML model is obtained at UE).

In both UE-specific or gNB-specific structures, the ML model may predict beams or beam pairs considering beams from a specific codebook used in the gNB or UE for beam training. As the codebook may depend on antenna placement, hardware impairments, and beam shape design properties/goals, the trained ML model for a UE/gNB may not be reused for another UE/gNB, which makes ML-based solutions less attractive.

For example, ML-based beam prediction without generalization/scalability aspects may result in the following challenges: (1) different ML models corresponding to different UE vendor codebook configurations are required; (2) different ML models corresponding to different network vendor codebook configurations are required; (3) UE vendor specific datasets for training impose high training computational complexities and memory usage (if the ML model is obtained/trained at the gNB); and/or (4) gNB vendor specific datasets for training impose high training computational complexities and memory usage (if the ML model is obtained/trained at the UE).

According to embodiments of the present disclosure, there is providing a solution for beam management with generalization aspects. In this solution, a device obtains at least one beam measurement. The device further determines, based on the at least one beam measurement, measurement representation in a configurable direction space, wherein the measurement representation indicates a signal strength associated with the at least one beam measurement for a direction among a plurality of directions in the direction space.

In this way, the beam measurement(s) can be represented by the measurement representation (or referred to as virtual beam measurements) in the direction space, thereby enabling efficient further processing of the beam measurement(s) for beam management.

As a non-limiting example, beam measurements associated with different devices, e.g., various UEs or gNBs, can be mapped to corresponding measurement representation in the same direction space, thereby allowing constructing a training dataset for training a device-agnostic ML model. On the other hand, the trained device-agnostic ML model can be processed at a specific device for the beam (pair) prediction based on the measurement representation associated with the specific device.

Principles and embodiments of the present disclosure will be described in detail below with reference to the accompanying drawings. However, it is to be noted that these embodiments are illustrated as examples and not intended to limit scope of the present application in any way.

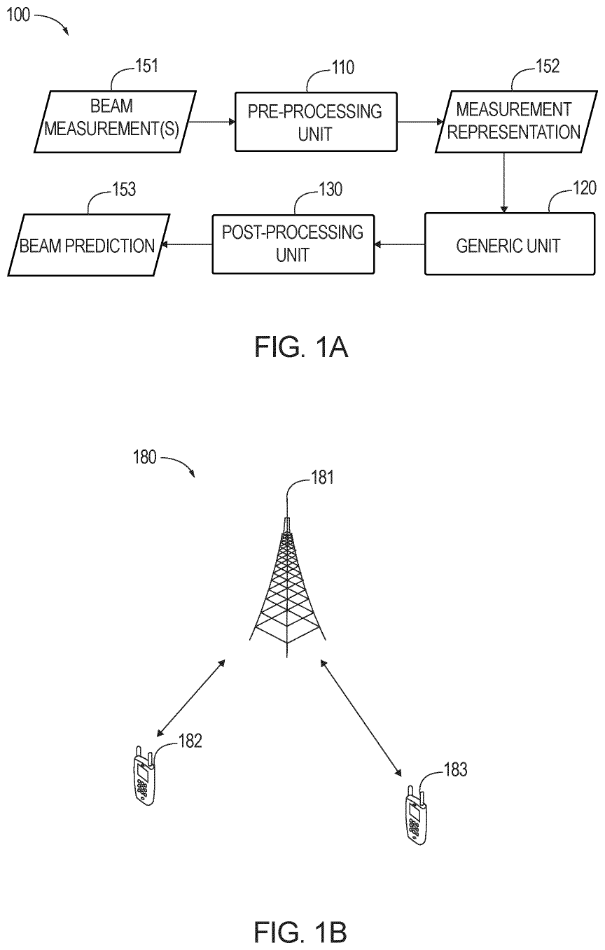

Reference is now made to FIG. 1A, which illustrates an example framework 100 in which embodiments of the present disclosure may be implemented. FIG. 1A illustrates a pre-processing unit 110, a generic unit 120 and a post-processing unit 130. The pre-processing unit 110, generic unit 120 and post-processing unit 130 may refer to models, algorithms, modules, blocks or methods that perform computation according to configured rules.

As illustrated in FIG. 1A, in the example framework 100, beam measurement(s) 151 may be input into the pre-processing unit 110. The pre-processing unit 110 may map or convert the beam measurement(s) 151 into measurement representation 152 in a configurable direction space.

The term “beam measurement” herein may refer to any suitable measurement related to a beam from a beam codebook. In some embodiments, the beam measurement may comprise a received signal strength (RSS) measurement. Alternatively or additionally, the beam measurement may comprise a reference signal received power (RSRP) measurement. Alternatively or additionally, the beam measurement may comprise a CSI-RS measurement.

The term “measurement representation” herein may refer to virtual measurement(s) that represents the actual beam measurement(s) in a configurable/defined direction space. The direction space may comprise or be constructed by a plurality of directions. The measurement representation indicates a respective signal strength, associated with the actual beam measurement(s), for each direction of the plurality of directions in the direction space. In other words, the measurement representation may indicate a distribution of the beam measurement(s) over the direction space, and a respective signal strength corresponding to each direction among the plurality of directions is determined from the beam measurement(s).

The mapping from the beam measurement(s) 151 of beam(s) in the beam codebook (i.e., a beam space) to the measurement representation 152 in the direction space may depend on antenna beamforming gain (also referred to as antenna gain for short) provided by the beams in the beam codebook at the plurality of directions in the direction space. The details of this mapping will be described hereafter.

In some embodiments, the measurement representation 152 may be input into the generic unit 120, e.g., a generic ML model or a statistical model. The generic unit 120 may determine a prediction result based on the measurement representation 152 in the input direction space. The generic unit 120 may predict a target or optimal direction in an output direction space for beam management.

The generic unit 120 may input the prediction result into the post-processing unit 130. The post-processing unit 130 may map or convert the prediction result (e.g., a target direction in the output direction space) into a beam prediction 153. The beam prediction 153 may be any suitable prediction for beam management. For example, the beam prediction 153 may indicate a target beam or a target beam pair to be selected in a target beam space. The mapping from the output direction space to the beam space may depend on the antenna beamforming gain, provided by the beams in the target beam space, for the directions in the output direction space.

It is to be understood that in FIG. 1A, the pre-processing unit 110, generic unit 120 and post-processing unit 130 are only for the purpose of illustration without suggesting any limitations. The framework 100 may include any suitable unit adapted for implementing embodiments of the present disclosure.

In various use cases, the pre-processing unit 110, generic unit 120 and post-processing unit 130 may be implemented or processed at one or more devices, e.g., one or more network devices and/or one or more terminal devices in a communication system. FIG. 1B illustrates an example communication system 180 in which embodiments of the present disclosure may be implemented. As illustrated in FIG. 1B, the communication system 180 may comprise a network device 181, a terminal device 182 and a terminal device 183.

As a non-limiting example, the pre-processing unit 110 may be processed at the terminal device 182 and terminal device 183, respectively. The post-processing unit 130 may be processed at the terminal device 182 and the terminal device 183, respectively. The generic unit 120 may be processed at the network device 181 that communicates with the terminal devices 182 and 183. The generic unit 120 may be able to process respective measurement representation associated with the terminal devices 182 and 183 in a generic way. In other words, the beam measurements associated with the terminal devices 182 and 183 may be represented in a common direction space and input into the generic unit 120 for prediction in a device-agnostic way.

Communications in the communication system 180 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

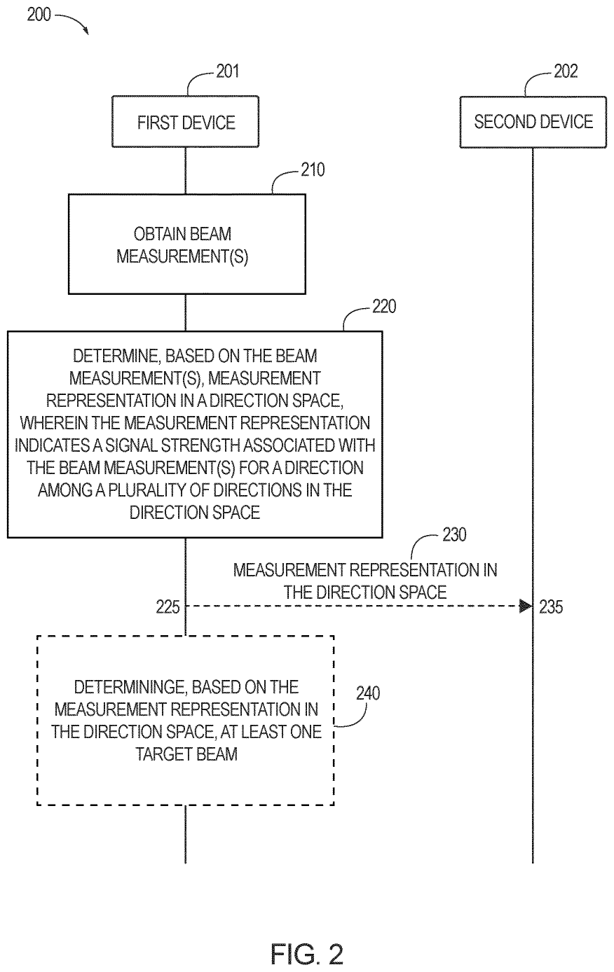

Reference is now made to FIG. 2, which shows an example of a process 200 for beam management according to an embodiment of the present disclosure. For the purpose of discussion, the process 200 will be described with reference to FIG. 1A and FIG. 1B.

As illustrated in FIG. 2, a first device 201 and a second device 202 may be involved in the process 200. In some embodiments, the first device 201 may be a terminal device (e.g., terminal device 182 or terminal device 183) and the second device 202 may be a network device (e.g., network device 181). Alternatively, the first device 201 may be a network device and the second device 202 may be a terminal device. Alternatively, the first device 201 may be a network device and the second device 202 may be a different network device.

In the process 200, the first device 201 obtains 210 at least one beam measurement. As described with reference to FIG. 1A, the beam measurement(s) may be RSRP measurement(s), RSS measurement(s) and/or CSI-RS measurement(s). The first device 201 further determines 220, based on the beam measurement(s), measurement representation in a direction space. The measurement representation indicates a signal strength, associated with the beam measurement(s), for a direction among a plurality of directions in the direction space. For example, the first device 201 may use the pre-processing unit 110 to determine the measurement representation in the direction space.

As a non-limiting example, the beam measurement(s) may be related to a set of beams in a beam codebook CB^{B} comprising a number of N_{B} beams, and the beam measurement related to beam n may be denotes as

$${R}_{n}^{C {B}^{B}} .$$

The pre-processing unit 110 may map the beam measurements(s)

$${R}_{n}^{C {B}^{B}} ,$$

n=1, . . . , N^{B} into measurement representation

$${R}_{k}^{{G}^{B}} ,$$

k=1, . . . , K^{B} in a direction space G^{B} comprising a number of K^{B} directions. The signal strength for direction k may be denoted as

$${R}_{k}^{{G}^{B}} .$$

The details of mapping the beam measurement(s) into the measurement representation will be described hereafter.

As illustrated in FIG. 2, in some embodiments, the first device 201 may transmit 225 the determined measurement representation 230 to the second device 235 for further processing. The second device 202 may receive 235 the measurement representation 230 and use the received measurement representation 230 for determining at least one target beam from a beam set. Alternatively or additionally, the first device 201 may determine 240, based on the measurement representation 230 in the direction space, at least one target beam from a beam set.

As an example, the beam measurement(s) 230 may be related to or associated with a Set B of beams (also referred to as Set B for short), and the first device 201 and/or second device 202 may use the beam measurement(s) 230 to determine target beam(s) from a Set A of beams (also referred to as Set A for short). The Set B and Set A may be specific to a same device, e.g., a same terminal device or network device. In such case, a beam selection for the specific device may be performed based on the measurement representation 230.

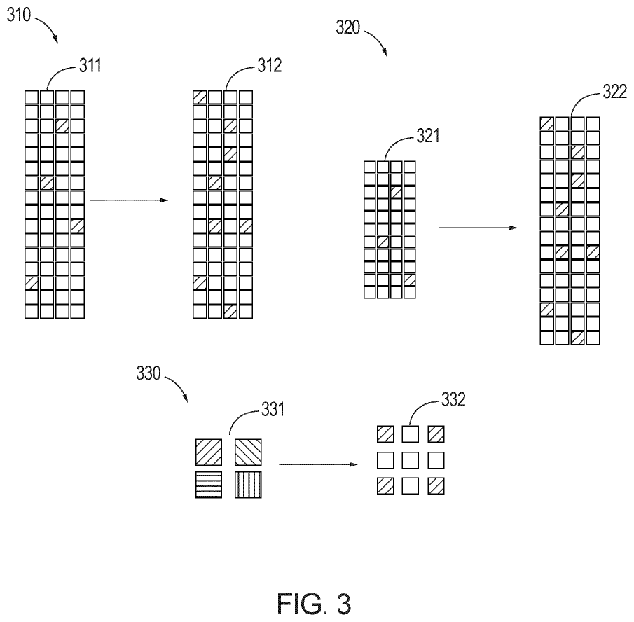

FIG. 3 illustrates examples of a process 300 for beam selection according to some embodiments of the present disclosure. As illustrated in FIG. 3, in a process 310, codebook B 311 and codebook A 312 may be the same. A Set B of beams in the codebook B 311, which is shown in solid, may be measured to obtain beam measurements for selecting, predicting or determining at least one target beam of Set A of beams (shown in solid) in the codebook A 312. The Set B may be a subset of the Set A.

Alternatively, in a process 320, codebook B 321 and codebook A 322 may be different. The Set B in the codebook B 321 may be different from the Set A in the codebook A 322. Alternatively, in a process 330, Set B in the codebook B 331 may comprise wider beams and Set A in the codebook A 332 may comprise narrower beams. The Set B in the codebook B 331 may be measured for selecting at least one target narrow beam in the Set A (shown in solid) in the codebook A 332.

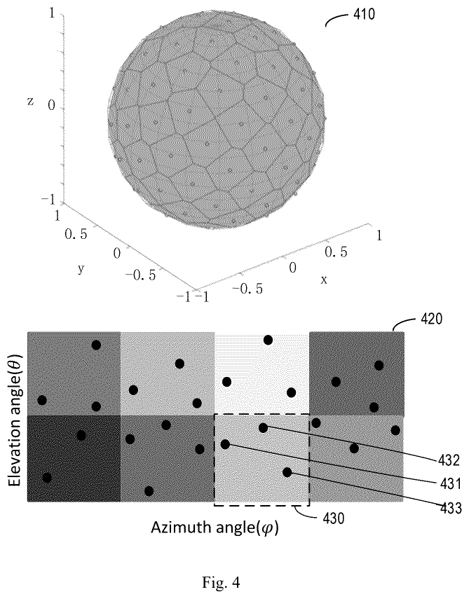

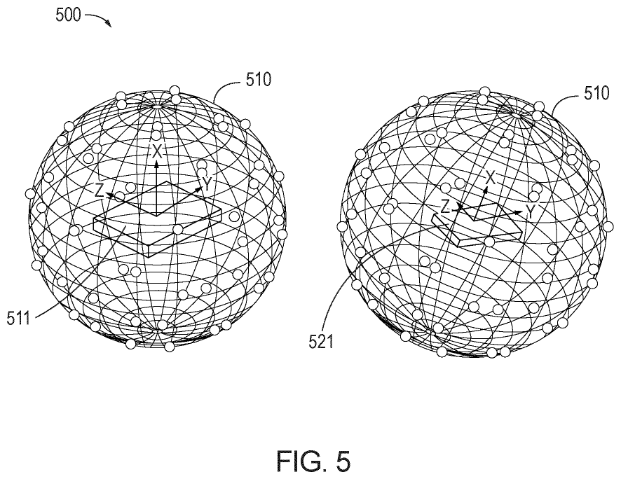

Reference is now made to FIGS. 4 to 5 to describe the details of mapping the beam measurement(s)<

$$( e . g . , {R}_{n}^{{CB}^{B}} )$$

into the measurement representation

$$( e . g . , {R}_{k}^{{G}^{B}} )$$

in the direction space. FIG. 4 illustrates an example of a direction space 410 and example associations between beams and directions according to some embodiments of the present disclosure. For the purpose of discussion, the process 400 will be described with reference to FIGS. 1A to 3.

FIG. 4 illustrates an example direction space 410. The direction space 410 may be used for discretizing azimuth and elevation angles of beams with a plurality of directions. As illustrated in FIG. 4, the direction space 410 may be defined by a grid and a point of the grid may represent a direction among the plurality of directions in the direction space 410. For example, the direction space 410 may be defined by a Fibonacci grid with 100 points. Any other suitable grid may be used for defining the direction space and the scope of the present disclosure is not limited in this aspect.

FIG. 4 further illustrates an example graph 420 showing associations between beams in the beam space and directions in the direction space 410. For the purpose of illustration, the direction space 410 is flatten into the two-dimensional graph 420 with points and each point represents a direction in the direction space 410.

As illustrated in FIG. 4, each point (i.e., direction) in the direction space 410 may be associated to a specific beam of the beam codebook and each beam may be represented by a coloured beam region. For example, as illustrated in the graph 420, considering a codebook with 8 beams, each point in the direction space 410 may be assigned to one of the 8 beam regions. The points 431, 432 and 433 may be associated to the beam region 430. In other words, the associations may indicate a beam region or a direction set or for each beam in the beam codebook. The direction set associated with beam n in the beam codebook B may be denoted as

$${S}_{n}^{B} .$$

In some embodiments, the direction set associated with each beam in the beam codebook (e.g., codebook B) may be determined based on antenna gain or response, from beams in the beam codebook, for each direction in the direction space 410. For each beam, the associated direction set may comprise one or more directions in the direction space 410 that are provided by the beam with the highest antenna gain among beams in the beam codebook.

For example, for direction k=1, . . . , K^{B} in the direction space G^{B}, the antenna gain of beam n in the codebook B may be denoted as

$$A {G}_{n , k}^{B} .$$

The direction set

$${S}_{n}^{B}$$

associated with beam n in the codebook B may be determined according to the following formula (1).

$$n = {arg max}_{i} {AG}_{i , k}^{B} ↔ k ∈ {S}_{n}^{B} \qquad ( 1 )$$

As can be seen from the formula (1), the direction set

$${S}_{n}^{B}$$

may collect indices or the grid points (i.e., directions) for which the beam n provides the highest gain compared to other beams. For example, based on the antenna gain

$$A {G}_{n , k}^{B}$$

of beam n=1, . . . , N^{B} for direction k, the direction k may be assigned to a direction set

$${S}_{X}^{B}$$

associated with a specific beam x that provides the highest antenna gain than the other beams in the beam codebook B.

The direction set associated with a beam may be also considered, interpreted or defined as a beam region associated with the beam. The beam region associated with beam n may be defined as a part of the direction space (e.g., the sphere) where the beam n is dominant (i.e., providing the highest antenna gain). For example, as illustrated in the graph 420, the beam region 430 associated with a beam x may comprise points 431, 432 and 433. For each of the points 431, 432 and 433, the beam x provides the highest antenna gain than the other beams in the beam codebook. In other words, the direction set

$${S}_{n}^{B}$$

may collect indices of the grid points that are in the beam region of beam n.

In some embodiments, the antenna gain associated with the beams in the beam codebook for each direction in the direction space 410 may be determined based on a calibration procedure. The calibration procedure may be performed via measurement and/or simulation. The calibration procedure may be specific to a device and/or a beam codebook.

FIG. 5 illustrates an example of a process 500 of determining antenna gain associated with the beam codebook for each direction in the direction space according to some embodiments of the present disclosure. For the purpose of discussion, the process 500 will be described with reference to FIGS. 1A to 4.

FIG. 5 illustrates a direction space 510 associated with a device 511 and a device 521. The direction space 510 may be an example of the direction space 410 as described with reference to FIG. 4. The devices 511 and 521 may be examples of the first device 201 or second device 202 as described with reference to FIG. 2.

As illustrated in FIG. 5, the antenna gain associated with the beams in the beam codebook for each direction in the direction space 510 may be determined by measuring and/or simulating the antenna gain associated with each beam in the beam codebook for each direction in the direction space 510. For example, the device 511 may use each beam in the beam codebook to transmit signals sequentially, thereby obtaining the antenna gain associated with each beam for each direction in the direction space 510. Similarly, the device 521 may use each beam of the beam codebook to transmit signals sequentially, thereby obtaining the antenna gain associated with each beam for each direction in the direction space 510. Any suitable procedures for determining the antenna gains associated with the beam codebook for each direction in the direction space may be applicable and the scope of the present disclosure is not limited in this aspect.

Note that, in the calibration procedure, a common coordinate system may be defined for various devices, such that the beam measurements associated with various devices can be represented by corresponding measurement representation in a common direction space. Additionally, if a device has multiple panels, beams from multiple panels may be calibrated based on the common coordinate system.

As illustrated in FIG. 5, for different devices 511 and 521, the direction space 510 may be based on a commonly-defined coordinate system. For example, a common Cartesian coordinate system may be defined wherein the X axis is perpendicular to the display screens of the device (e.g., devices 511 and 521), the Y axis is directed to the top faces of the device (e.g., devices 511 and 521) and the Z axis is directed to the side faces of the device (e.g., devices 511 and 521). In this way, regardless of rotation of the devices, beam measurements associated with various devices may be respectively represented by the measurement representation for same directions in the common direction space 510.

In some embodiments, the common direction space may be configured or pre-defined, e.g., by device vendors or the specification. For example, the Fibonacci grid with 100 points, 200 points, or 300 points may be used to define the common direction space. Alternatively, a list of pre-defined common direction spaces may be pre-defined and a selection of the common direction space may be supported.

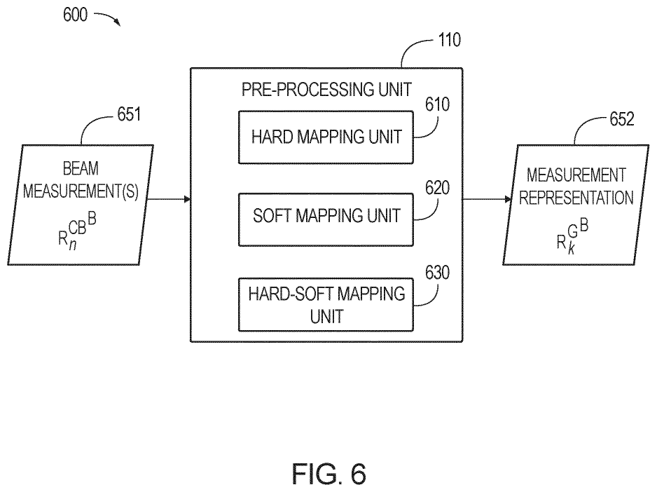

FIG. 6 illustrates an example of a process 600 of mapping the beam measurements into the measurement representation in the direction space according to some embodiments of the present disclosure. For the purpose of discussion, the process 600 will be described with reference to FIG. 1A.

As illustrated in FIG. 6, a hard mapping unit 610, a hard-soft mapping unit 620 and/or a soft mapping unit 630 in the pre-processing unit 110 may be used for mapping the beam measurement(s) 651 into the measurement representation 652. In some embodiments, one of the mapping results of the hard, soft, hard-soft mapping units may be determined as the measurement representation 652. Alternatively, one or more mapping results of the mapping units may be combined to determine the measurement representation 652.

The beam measurement(s) 651 associated with the Set B of beams may be an example of the beam measurement(s) 151 as described with reference to FIG. 1A and the beam measurement(s) 651 may be denoted as

$${R}_{n}^{C {B}^{B}} .$$

The measurement representation 652 may be an example of the measurement representation 152 as described with reference to FIG. 1A and the measurement representation may be denoted as

$${R}_{k}^{{G}^{B}} .$$

In some embodiments, the hard mapping unit 610 may use a hard mapping scheme to map the beam measurement(s) 651 associated with the Set B into the measurement representation 652. The hard mapping unit 610 may determine the signal strength for each direction among the plurality of directions in the direction space based on a beam measurement of a beam that provides the highest antenna gain among the Set B.

For example, the hard mapping unit 610 may determine the measurement representation 652 according to the following formula (2).

$${R}_{k}^{{G}^{B}} = {\sum }_{n = 1}^{{N}^{B}} {I}_{n , k}^{B} {α}_{n}^{B} {R}_{n}^{{CB}^{B}} where {I}_{k}^{n} \qquad ( 2 )$$

represents an information variable to define the relation or associations between the beams in the codebook and directions in the direction space, and

$${α}_{n}^{B}$$

represents a normalization factor for beam n.

The information variable

$${I}_{k}^{n}$$

may be defined as the following formula (3). Note that a grid point is only assigned into one of the beam regions, so

$${\sum }_{n = 1}^{{N}^{B}} {I}_{n , k}^{B} = 1 , ∀ k .$$

$${I}_{n , k}^{B} = \{ \begin{matrix}0 , & if k ∉ {S}_{n}^{B} \\ 1 , & if k ∈ {S}_{n}^{B}\end{matrix} \qquad ( 3 )$$

In some embodiments,

$${α}_{n}^{B}$$

may be defined as 1 for all beams in the beam set, i.e.,

$${α}_{n}^{B} = 1 ,$$

∀n. Alternatively, the beam measurements may be normalized based on coverage of each beam region. For example, it may defined that

$${α}_{n}^{B} = \frac{1}{\vert {S}_{n}^{B} \vert} ,$$

∀n, where

$$\vert {S}_{n}^{B} \vert$$

denotes the cardinality of the

$${S}_{n}^{B} .$$

In other words, the beam measurements may be normalized based on a number of directions in the direction set

$${S}_{n}^{B}$$

associated with the beam n.

According to the formulas (2) to (3), the hard mapping unit 610 may determine, for each direction k in the direction space, a specific beam x that provides the highest antenna gain for the direction k among the Set B. The hard mapping unit 610 may further determine the beam measurement of the specific beam x as the signal strength for the direction k. Alternatively, the hard mapping unit 610 may determine the beam measurement of the specific beam x, normalized by

$${α}_{n}^{B} = \frac{1}{\vert {S}_{n}^{B} \vert} ,$$

as the signal strength for the direction k.

Alternatively or additionally, the soft mapping unit 620 may use a soft mapping scheme to map the beam measurement(s) 651 associated with the Set B into the measurement representation 652. The soft mapping unit 620 may determine the signal strength for each direction among the plurality of directions in the direction space based on a distribution of the beam measurement(s) 651 of the Set B.

Specifically, in the soft mapping scheme, considering that the power received by a beam may be distributed over the direction space proportionally to the beam antenna gain

$$A {G}_{n , k}^{B}$$

at the directions in the direction space, a distributed power (i.e., a distributed beam measurement) of each beam over the direction space may be determined based on the beam antenna gain

$$A {G}_{n , k}^{B} .$$

As such, it gives more power to the directions with higher antenna gains than those with low antenna gains.

For example, the distributed power or distributed beam measurement for the direction k may be denoted as

$${R}_{n , k}^{B} ,$$

which can be conducted as a portion of the beam measurement

$${R}_{n}^{C {B}^{B}}$$

that is associated with the direction k. The soft mapping unit 620 may determine the measurement representation 652 according to the following formulas (4) and (5), where

$${η}_{n , k}^{B}$$

represents a power distribution factor based on the antenna gain

$$A {G}_{n , k}^{B} .$$

$${R}_{n , k}^{B} = {η}_{n , k}^{B} {R}_{n}^{C {B}^{B}} , ∀ k , n \qquad ( 4 )$$

$${R}_{k}^{{G}^{B}} = {\sum }_{n = 1}^{{N}^{B}} {R}_{n , k}^{B} , ∀ k , n \qquad ( 5 )$$

In some embodiments, the power distribution factor

$${η}_{n , k}^{B}$$

may be defined as the following formula (6).

$${η}_{n , k}^{B} = \frac{{\vert {AG}_{n , k}^{B} \vert}^{2}}{{\sum }_{k = 1}^{{K}^{B}} {\vert {AG}_{n , k}^{B} \vert}^{2}} , ∀ k , n \qquad ( 6 )$$

Note that the power distribution factor

$${η}_{n , k}^{B}$$

may be defined based on the antenna gain in any other suitable way. For example, it may be defined based on a first order of the antenna gain instead of the second order of the antenna gain.

As can be seen from the above formulas (4) to (6), the soft mapping unit 620 may determine a distribution of beam measurements over the direction space, i.e., a distributed beam measurement

$${R}_{n , k}^{B}$$

associated with the direction k. The soft mapping unit 620 may further aggregate the distributed beam measurements

$${R}_{n , k}^{B}$$

from different beams to construct the synthetic signal strength for the direction k in the direction space, thereby determining the measurement representation

$${R}_{k}^{{G}^{B}} ,$$

k=1, . . . , K^{B}.

Alternatively or additionally, the hard-soft mapping unit 630 may use a hard-soft mapping scheme to map the beam measurement(s) 651 associated with the Set B into the measurement representation 652. The hard-soft mapping unit 630 may determine the signal strength for each direction among the plurality of directions in the direction space based on a distribution of a beam measurement of a beam that provides the highest antenna gain among the Set B.

Compared to the soft mapping scheme as described above, in the hard-soft mapping scheme, the hard-soft mapping unit 630 may not determine a distribution of beam measurements over all of the direction space and aggregate the distributed beam measurement from all of the Set B of beams.

Instead, the hard-soft mapping unit 630 may determine, from the Set B, the specific beam x that provides the highest antenna gain for the direction k. The hard-soft mapping unit 630 may further determine the distribution of the beam measurement of the specific beam x over the direction set (i.e., beam region) corresponding to the specific beam x. The hard-soft mapping unit 630 may determine the distribution over the direction set based on the antenna gain provided by the specific beam x for the direction set. The hard-soft mapping unit 630 may further use the distributed beam measurement

$${R}_{X , k}^{B}$$

of the specific beam x to construct the synthetic signal strength for the direction k in the direction space.

For example, the hard-soft mapping unit 630 may determine the measurement representation 652 according to the following formulas (7) to (9), wherein

$${I}_{n , k}^{B}$$

denotes the information variable as described with the formula (3).

$${R}_{n , k}^{B} = {η}_{n , k}^{B} {R}_{n}^{{CB}^{B}} , ∀ k , n \qquad ( 7 )$$

$${η}_{n , k}^{B} = \{ \begin{matrix}0 , if k ∉ {S}_{n}^{B} \\ \frac{{\vert {AG}_{n , k}^{B} \vert}^{2}}{{\sum }_{k ∈ {S}_{n}^{B}} {\vert {AG}_{n , k}^{B} \vert}^{2}} , if k ∈ {S}_{n}^{B}\end{matrix} \qquad ( 8 )$$

$${R}_{k}^{{G}^{B}} = {\sum }_{n = 1}^{{N}^{B}} {I}_{n , k}^{B} {R}_{n , k}^{B} , ∀ k , n \qquad ( 9 )$$

As can be seen from the above formulas (7) to (9), the hard-soft mapping unit 630 may determine the distributed beam measurement

$${R}_{X , k}^{B}$$

from the specific beam x to construct the synthetic signal strength for the direction k in the direction space, thereby determining the measurement representation

$${R}_{k}^{{G}^{B}} ,$$

k=1, . . . , K^{B}. In addition, the distributed beam measurement

$${R}_{X , k}^{B}$$

may be determined based on only the antenna gain of the specific beam x for the directions in the corresponding direction set.

Based on the determined measurement representation in the input direction space, referring back to FIG. 1A, the generic unit 120 may determine a probability distribution for a plurality of directions in a second (output) direction space. The probability distribution may indicate, for each of the plurality of directions in the second direction space, a probability that a beam corresponding to the direction is the optimal beam for beam management, e.g., beam selection. Alternatively or additionally, the probability distribution may indicate a specific direction with the highest probability that a beam corresponding to the direction is the optimal beam for beam management.

In some embodiments, the generic unit 120 may map information from the first direction space to the second direction space to determine the probability distribution by using a ML model. The ML model may be generic to terminal devices or network devices and/or beam codebooks depending on the use cases. As an example, the ML model that is generic to terminal devices may be processed at a network device for a beam selection of each of the terminal devices. As another example, the generic unit 120 that is generic to network devices may be processed at a terminal device for a beam selection of each of the network devices.

In some embodiments, the generic unit 120 may have an input dimension equal to the number of directions in the input direction space and an output dimension equal to the number of directions in the output direction space. Alternatively, any suitable supplementary unit may perform a dimension conversion for the generic unit 120.

In some embodiments, the first/input direction space may be associated with the Set B, and the second/output direction space may be associated with the Set A. In some embodiments, the first direction space may be the same as the second direction space. Alternatively, the first direction space may be different from the second direction space.

As an example, the generic unit 120 may process the measurement representation in the input direction space associated with the Set B to output a probability distribution for the directions in the output direction space associated with the Set A according to the following formula (10).

$${P}_{k}^{{G}^{A}} = {ℙ}^{{G}^{A}} [ k = {k}^{*} ] \qquad ( 10 )$$

where k* denotes the optimal direction in the output direction space G^{A}, and [symbol] [k=k*] denotes the probability that the direction k is the optimal direction. It is worth to highlight that whether wide beams or narrow beams are measured as the inputs to the pre-processing unit 110, the ML model may interpret/propose the optimal direction for communication using limited information.

Based on the determined probability distribution in the output direction space, the post-processing unit 130 may determine at least one target beam from the beam set (e.g., Set A) associated with the output direction space. The post-processing unit 130 may map the probability distribution for directions in the output direction space into a probability distribution for the beam set associated with the output direction space, thereby determining the beam prediction 153. The post-processing unit 130 may use a post-mapping scheme to map information from the output direction space to the beam set space. The post-mapping scheme may be similar to the mapping scheme as described with reference to FIG. 6 but it is a converse procedure.

In some embodiments, the post-processing unit 130 may determine a probability for a beam in the beam set associated with the output direction space by aggregating probabilities of a direction set associated with the beam. As described with reference to FIG. 6, the direction set (i.e., beam region) associated with the beam may be determined based on the antenna gain, associated with the beams in the beam codebook, for each of the directions in the direction space. The details are omitted herein. Any other suitable post-mapping scheme may be used and the scope of the present disclosure is not limited in this aspect.

As an example, the post-processing unit 130 may process the probability distribution for the directions,

$${P}_{k}^{{G}^{A}} ,$$

and output the probability distribution for beams in the Set A in the codebook A (CB^{A}),

$${P}_{n}^{{CB}^{A}} ,$$

according to the following formulas (11) to (13).

$${P}_{n}^{{CB}^{A}} = {\sum }_{k = 1}^{{K}^{A}} {I}_{n , k}^{A} {P}_{k}^{{G}^{A}} , ∀ n = 1 , … , {N}^{A} \qquad ( 11 )$$

$${I}_{n , k}^{A} = \{ \begin{matrix}0 , if k ∉ {S}_{n}^{A} \\ 1 , if k ∈ {S}_{n}^{A}\end{matrix} \qquad ( 12 )$$

$$n = {arg max}_{i} {AG}_{i , k}^{A} ↔ k ∈ {S}_{n}^{A} where {S}_{n}^{A} \qquad ( 13 )$$

stores indices of the direction set associated with beam

$${B}_{n}^{C {B}^{A}} ,$$

i.e., the directions that are in the beam region of beam

$${B}_{n}^{C {B}^{A}} . {S}_{n}^{A}$$

may be defined using the antenna gain of beam

$${B}_{n}^{C {B}^{A}}$$

at the direction k or G^{A},

$$A {G}_{n , k}^{A} . {S}_{n}^{A}$$

may collect the indices of the directions that the beam

$${B}_{n}^{C {B}^{A}}$$

provides the highest gain compared to the other beams in the codebook CB^{A}.

Based on the probability distribution for beams in the Set A in the codebook CB^{A},

$${P}_{n}^{C {B}^{A}} ,$$

the post-processing unit 130 may determine, from the Set A in the codebook CB^{A}, the beam nₛ that has the highest probability

$${P}_{ n}^{{CB}^{A}}$$

as the best beam according to the following formula (14).

$${n}_{s} = {arg max}_{n = 1 , … , {N}^{A}} {P}_{n}^{{CB}^{A}} \qquad ( 14 )$$

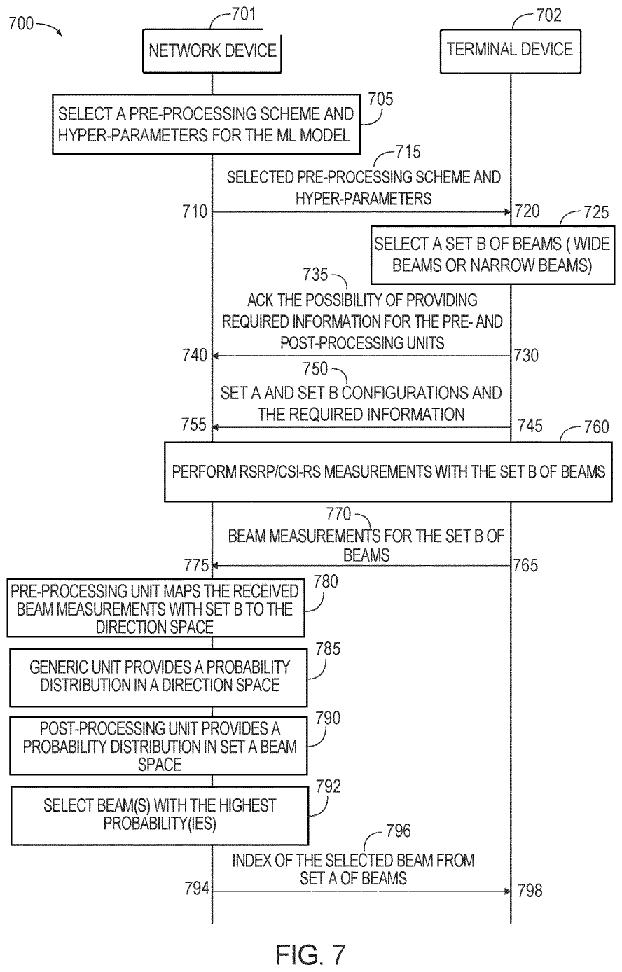

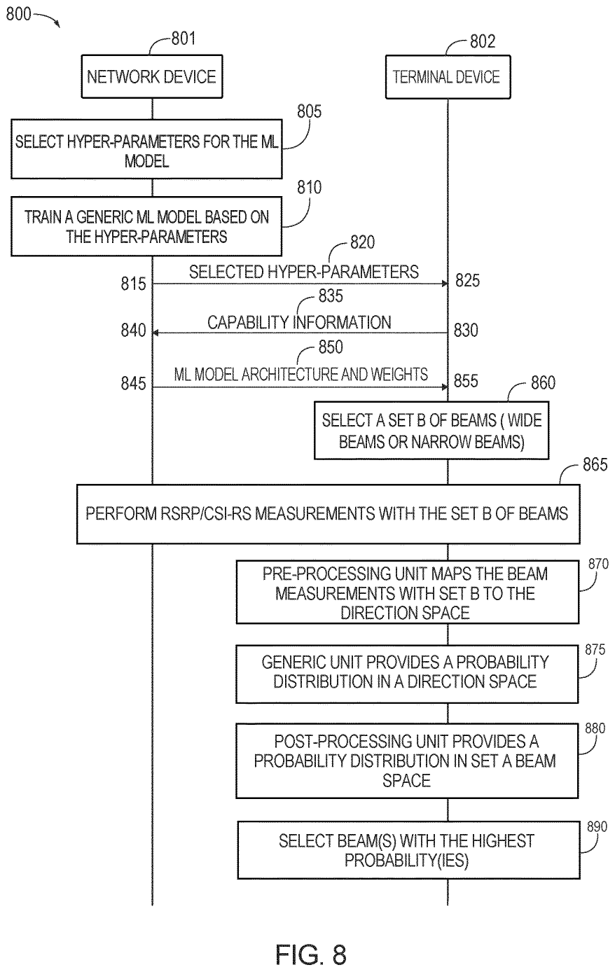

Reference is now made to FIGS. 7 to 8, which show examples of processes 700, and 800 for beam management according to an embodiment of the present disclosure. It is noted that these processes 700 and 800 can be deemed as more specific examples of the process 200. It would be appreciated that these processes 700 and 800 may be applied to the communication system 180 of FIG. 1B and any other similar communication scenarios. For the purpose of illustration, the processes 700 and 800 may be described with reference to FIGS. 1A and 1B.

FIG. 7 illustrates an example of the process 700 for a DL Rx beam prediction according to an embodiment of the present disclosure. As illustrated in FIG. 7, a network device 701 and a terminal device 702 may be involved in the process 700.

In the process 700, a generic ML model may be trained at the network device 701. The generic ML model may be a UE-agnostic ML model and it may be trained or developed based on a training dataset constructed by data from various terminal devices. In addition, the generic ML model may be trained or developed considering propagation properties from the environment.

The network device 701 may also use the trained ML model for inference, e.g., predicting a DL Rx beam for the terminal device 702. The network device 701 may use beam measurements(s) of the Set B,

$${R}_{n}^{C {B}^{B}} ,$$

n=1, . . . , N^{B}, to predict a target beam in the Set A as the DL Rx beam for the terminal device 702.

As illustrated in FIG. 7, the network device 701 may select 705 a pre-processing scheme and hyper-parameters of the ML model. The network device 701 may select 705 a hard-mapping, soft-mapping or hard-soft mapping for mapping beam measurement(s) in the beam space to measurement representation in the direction space.

The hyper-parameters may comprise information related to a way of discretizing the azimuth and elevation angles in the direction space, e.g., a “Fibonacci grid” with “100 points”. The hyper-parameters may comprise an input dimension and an output dimension of the ML model. As described above, the input dimension may be equal to the number of directions (i.e., grid size) in the input direction space and the output dimension may be equal to the number of directions (i.e., grid size) in the output directions space.

In some embodiments, a list of input dimensions and output dimensions may be pre-defined, e.g., by device vendors and/or the specification. The network device 701 may select 705 an input dimension and output dimension from the list for constructing the ML model. In some embodiments, the network device 701 may receive, from the terminal device 702, input dimension information indicating at least one input dimensions supported by the terminal device 702, and/or output dimension information indicating at least one output dimensions supported by the terminal device 702. The network device 701 may select 705, based on the received information, an input dimension and output dimension for constructing the ML model.

The network device 701 may transmit 710 the selected pre-processing scheme and the hyper-parameters 715 to the terminal device 702. The terminal device 702 may receive 720 the selected pre-processing scheme and the hyper-parameters 715. Although it is not shown here, the network device 701 may further transmit the selected pre-processing scheme and the hyper-parameters 715 to other terminal devices and collect data from them for training the ML model.

The terminal device 702 may select 725 a desired Set B of beams for obtaining beam measurement(s) for the DL Rx beam prediction. The desired Set B may comprise wide beams or narrow beams. The Set B in the inference time may be different than the Set B used in the training stage. The terminal device 702 may further select a desired Set A of beams from which one or more target beams are to be selected. Similarly, the Set A in the inference time may be different than the Set A used in the training stage.

The terminal device 702 may transmit 730, to the network device 701, an acknowledgement 735 that it is possible to provide required information for the pre-processing unit 110 and the post-processing unit 130. The network device 701 may receive 740 the acknowledgement 735. The required information may comprise forward mapping information for the pre-processing unit and backward mapping information for the post-processing unit.

The forward mapping information may be associated with antenna gain, for a direction among the plurality of directions in the input direction space, of each beam that is to be measured for obtaining the beam measurement(s). In some embodiments, the forward mapping information may indicate the antenna gain, for each direction among the plurality of directions in the input direction space, of a beam in the beam codebook B. For example, the forward mapping information may indicate antenna gain

$$A {G}_{n , k}^{B}$$

k, and n=1, . . . , N^{B}, k=1, . . . , K^{B}.

Alternatively or additionally, the forward mapping information may indicate a direction set associated with a beam, wherein the direction set comprises one or more directions in the direction space that are provided by the beam with the highest antenna gain among beams in the beam codebook. In other words, the forward mapping information may indicate a direction set or a beam region associated with a beam in beam codebook B. For example, the forward information may indicate a direction set

$${S}_{n}^{B}$$

associated with the beam n in the codebook B.

Note that, the forward mapping information may vary depending on the selected pre-processing scheme. As an example, if the hard mapping scheme is selected, the forward mapping information may comprise information of the direction set

$${S}_{n}^{B} .$$

As another example, if the soft mapping scheme is selected, the forward mapping information may comprise antenna gains of all the codebook beams at all the directions. As yet another example, if the hard-soft mapping scheme is selected, the forward mapping information may comprise antenna gains of beams at directions in the corresponding direction set. As such, the overhead of transmitting the forward mapping information may be reduced significantly compared to the soft mapping scheme.

Similarly, the backward mapping information may be associated with antenna gain, for a direction of the plurality of directions in the output direction space, of a beam in the beam set associated with the output direction space, e.g., the Set A. The backward mapping information may vary depending on the post-mapping scheme.

In some embodiments, the backward mapping information may indicate antenna gain, for a direction of the plurality of directions in the output direction space, of a beam in the beam codebook. For example, the backward mapping information may indicate antenna gain

$$A {G}_{n , k}^{A}$$

of beam n for direction k, and n=1, . . . , N^{A}, k=1, . . . , K^{A}.

Alternatively or additionally, the backward mapping information may indicate a direction set associated with a beam in the beam codebook, wherein the direction set comprises one or more directions in the output direction space that are provided by the beam with the highest antenna gain among the beams in the beam codebook. For example, the backward mapping information may indicate a direction set

$${S}_{n}^{A}$$

associated with the beam n in the codebook A.

In some embodiments, the terminal device 702 may determine a size of the Set B and a size of the Set A based on the received input dimension and output dimension of the ML model. For example, the input dimension may be linked to a specific size of codebook B used in the calibration procedure. Moreover, a maximum size of Set B may be linked to the codebook B, thus terminal device 702 may determine a size of Set B below the maximum size of Set B. The similar process for determining the size of Set A is omitted herein.

The terminal device 702 may transmit 745 Set A and Set B configurations and the required information 750 to the network device 701. The network device 701 may receive 755 the Set A and Set B configurations and the forward and backward mapping information.

The terminal device 702 may perform 760 RSRP/CSI-RS measurements with the Set B of beams and transmit 765 the beam measurements 770 for the Set B of beams to the network device 701. The network device 701 may receive 775 the beam measurements 770.

The network device 701 may use the pre-processing unit to map 780 the received beam measurements with the Set B to measurement representation in the input direction space. The network device 701 may use the generic ML model to provide 785, based on the measurement representation in the input direction space, a probability distribution of directions in the output directions space. The network device 701 may use the post-processing unit to provide 790 a probability distribution of the beams in the Set A beam space.

The network device 701 may select 792, based on the probability distribution of the Set A of beams, the best Rx beam with the highest probability among the Set A of beams. Additionally, the network device 701 may select more than one beams based on a ranking of the probabilities.

The network device 701 may transmit 794 a beam index 796 of the selected beam from the Set A to the terminal device 702. The terminal device 702 may receive 798 the beam index 796 and use the selected beam for communication with the network device 701.

Although it is not illustrated in FIG. 7, in some embodiments, the network device 701 or the terminal device 702 may transmit capability information indicating a capability of performing resource allocation (e.g., beam prediction) in a spatial domain without a beam codebook. For example, the network device 701 may transmit the capability information to the terminal device 702 to indicate that it is capable of performing beam prediction in the spatial domain not depending on a beam codebook (e.g. beam configuration/pattern used by the terminal device 702).

In some embodiments, the network device 701 may indicate (with the capability information signalling or via a separate method) that beam measurements are first considered in a pre-processing unit prior to applying a ML model. Alternatively or additionally, the network device 701 may indicate additional conditions for the pre-processing unit, e.g., the maximum dimension (supported input codebook dimensions) of the pre-processing unit, the minimum number of required measurements (per different codebook), etc.

In some embodiments, the network device 701 may indicate (with the capability information signalling or via a separate method) that the prediction of the ML model is later considered in a post-processing unit. Alternatively or additionally, the network device 701 may indicate additional conditions for the post-processing unit, e.g., the maximum dimension (supported output codebook dimension) of the post-processing unit, conditions/limitations/performances on supported output codebook(s) (used when remapping the ML output), etc.

In some embodiments, the network device 701 may consider the reported capability information and additional indications to configure the terminal device with any suitable beam measurement configuration and reporting configuration.

As illustrated in FIG. 7, the pre-processing unit, the post-processing unit and the ML model may be processed at the network device 701. The terminal device 702 may transmit required information for the pre-processing unit and the post-processing unit to the network device 701.

FIG. 8 illustrates another example of the process 800 for a DL Rx beam prediction according to an embodiment of the present disclosure. As illustrated in FIG. 8, a network device 801 and a terminal device 802 may be involved in the process 800.

In the process 800, a generic ML model may be trained at the network device 801. The network device 801 may transmit the trained ML model, e.g., architecture and weights of the trained ML model, to the terminal device 802 for inference. In addition, the pre-processing unit and the post-processing unit may be processed at the terminal device 802. In such case, compared to the process 700, the terminal device 802 may not need to share the required information for the pre-processing unit and the post-processing unit to the network device 801.

Specifically, in the process 800, the network device 801 may select 805 hyper-parameters for the ML model, e.g., an input dimension and an output dimension of the ML model. The hyper-parameters may comprise any other suitable parameters for constructing a ML model, for example, a learning rate or batch size. The network device 801 may train 810 a generic ML model based on the hyper-parameters.

In addition, although it is not shown here, the network device 801 may select a pre-processing scheme, e.g., a hard-mapping, soft-mapping or hard-soft mapping for mapping beam measurement(s) in the beam space to measurement representation in the direction space. The network device 801 may transmit the selected pre-processing scheme to the terminal device 802. Alternatively, the terminal device 802 may determine the pre-processing scheme rather than receiving it from the network device 801.

The network device 801 may transmit 815 the selected hyper-parameters 820 to the terminal device 802. The terminal device 802 may receive 825 the selected hyper-parameters 820. The terminal device 802 may transmit 830, to the network device 801, capability information 835 indicating capability of performing resource allocation in a spatial domain without measuring all beams in a beam codebook. For example, the capability information 835 may indicate that the terminal device 802 is capable of performing DL Rx beam prediction by using a generic ML model.

The network device 802 may receive 840 the capability information 835 and transmit 845 ML model architecture and weights 850 to the terminal device 802. The ML model architecture may comprise a number of layers, layer size, etc. The terminal device 802 may receive 855 the ML model architecture and weights 850, and re-construct the ML model that is already trained at the network device 801.

The terminal device 802 may select 860 a desired Set B of beams for obtaining beam measurement(s) for the DL Rx beam prediction. The desired Set B may comprise wide beams or narrow beams. The terminal device 802 may perform 865 RSRP/CSI-RS measurements with the selected Set B of beams.

Based on the obtained beam measurements, the terminal device 802 may use the pre-processing unit to map 870 the beam measurements with the Set B to measurement representation the input direction space. The terminal device 802 may use the generic ML model to provide 875, based on the measurement representation in the input direction space, a probability distribution of directions in the output directions space. The terminal device 802 may use the post-processing unit to provide 880 a probability distribution of the beams in the Set A beam space. The terminal device 802 may select 890, based on the probability distribution of the Set A of beams, the best Rx beam with the highest probability among the Set A of beams. Additionally, the terminal device 802 may select more than one beams based on a ranking of the probabilities.

As described earlier, the ML-based beam management may further comprise beam pair prediction based on a relationship between the Set B and Set A of beams. In this scenario, the Set B may comprise network (NW) or gNB Set B of beams and UE Set B of beams. The Set A may comprise NW or gNB Set A of beams and UE Set A of beams.

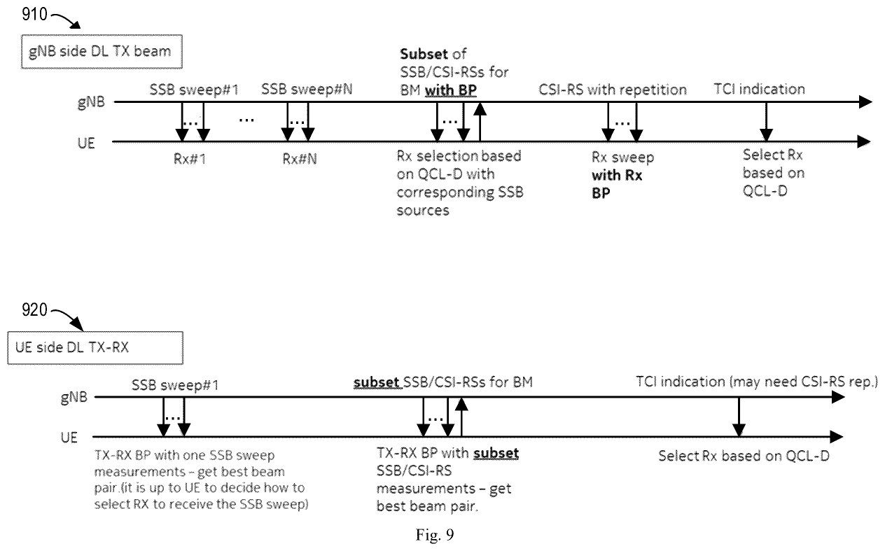

FIG. 9 illustrates examples of a process for beam pair prediction according to an embodiment of the present disclosure. FIG. 9 illustrates a process 910 of a DL Tx-Rx beam pair prediction using the ML model at the gNB and a process 920 of a DL Tx-Rx beam pair prediction using the ML model at the UE.

In the process 910, the ML model may be implemented at the gNB. The gNB may use the ML model to predict a subset of beams for performing SSB/CSI-RS measurements. Then the Rx beam may be selected based on quasi-colocation (QCL) Type D with the corresponding SSB resources. In addition, CSI-RS beam repetition at the gNB may be followed by Rx beam prediction (BP) at the UE.

Alternatively, in the process 920, the ML model may be implemented at the UE. A subset of SSB/CSI-RSs may be measured via one SSB sweep at the UE. The UE may use the ML model to predict, based on the subset of SSB/CSI-RS measurements, a Tx-Rx beam prediction (BP) to achieve the best Rx beam for the beam pair.

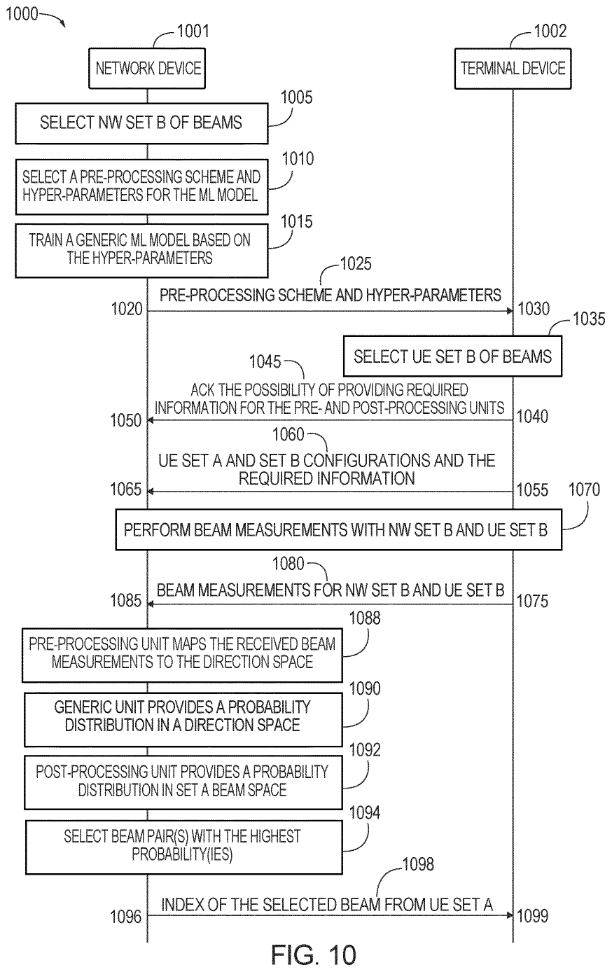

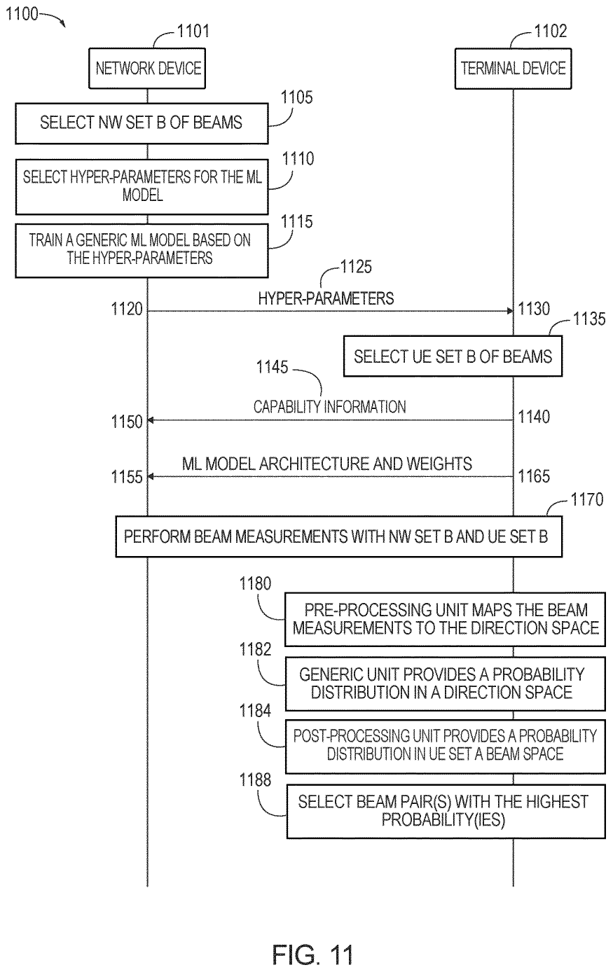

Reference is now made to FIGS. 10 to 11, which show examples of processes 1000, and 1100 for beam pair prediction according to an embodiment of the present disclosure. It is noted that these processes 1000 and 1100 can be deemed as more specific examples of the process 200. It would be appreciated that these processes 1000 and 1100 may be applied to the communication system 180 of FIG. 1B and any other similar communication scenarios. For the purpose of illustration, the processes 1000 and 1100 may be described with reference to FIGS. 1A and 1B.

FIG. 10 illustrates an example of the process 1000 for a DL Tx-Rx beam pair prediction according to an embodiment of the present disclosure. As illustrated in FIG. 10, a network device 1001 and a terminal device 1002 may be involved in the process 1000.

In the process 1000, a generic ML model may be trained at the network device 1001. The network device 1001 may further use the trained ML model for inference. The network device 1001 may process beam measurements with beam pairs from the Set B in the beam codebook B (CB^{B}) and predict a beam pair or a list of beam pairs from the Set A in the beam codebook A (CB^{A}). A beam pair in the Set B or Set A may comprise a Tx beam and a corresponding Rx beam. In addition, in the process 1000, the pre-processing unit and the post-processing unit may be processed at the network device 1001.

Specifically, in the process 1000, the network device 1001 may select 1005 a desired NW or gNB Set B of beams. The NW Set B of beams may comprise wide beams or narrow beams for beam prediction. As an example, the network device 1001 may use wide beams as the Set B to predict narrow beams in the NW Set A of beams. As another example, the network device 1001 may use sparse narrow beams as the Set B to predict narrow beams in the NW Set A of beams.

The network device 1001 may select 1010 a pre-processing scheme and hyper-parameters for the ML model. The network device 1001 may train 1015 the generic ML model based on the selected hyper-parameters. The network device 1001 may transmit 1020 the pre-processing scheme and the hyper-parameters 1025 to the terminal device 1002.

The terminal device 1002 may receive 1030 the pre-processing scheme and the hyper-parameters 1025.

The terminal device 1002 may select 1035 a desired UE Set B of beams for obtaining the beam measurements. The UE Set B may comprise wide beams or narrow beams. The terminal device 1002 may transmit 1040, to the network device 1001, an acknowledgement 1045 that it is possible to provide required information for the pre-processing unit 110 and the post-processing unit 130. The network device 1001 may receive 1050 the acknowledgement 1045. The required information may comprise forward mapping information for the pre-processing unit 110 and backward mapping information for the post-processing unit 130. The required information may be associated with UE Set A and UE Set B of beams, for example, antenna gains or direction sets associated with the UE Set A and UE Set B of beams.

The terminal device 1002 may transmit 1055 UE Set A and Set B configurations and required information 1060 to the network device 1001. The network device 1001 may receive 1065 the Set A and Set B configurations and required information 1060.

The terminal device 1002 may perform 1070 beam measurements with the network device 1001. The beam measurements may be performed with NW Set B and UE Set B of beams, i.e., Set B of beam pairs. The beam measurements may comprise RSRP and/or CSI-RS measurements. The terminal device 1002 may transmit 1075 the beam measurements for the NW Set B and UE Set B 1080 to the network device 1001. The network device 1001 may receive 1085 the beam measurements 1080.

The network device 1001 may use the pre-processing unit to map 1088 the received beam measurements with gNB Set B and UE Set B to measurement representation in the input direction space. Note that the gNB codebook A and B may be fixed for different UEs, thus the ML model may not need to be agnostic to the gNB codebooks. The pre-processing unit may map 1088 the beam measurements to measurement representation in an input direction space associated with the UE Set B. In this case, forward mapping information for the UE codebook B, antenna gain or a direction set associated with a beam of the UE codebook B may be used in the pre-processing unit.

Additionally, a gNB beam index of gNB Set B associated with the corresponding beam measurement may be combined (e.g., concatenated) with the measurement representation to obtain the measurement representation in a gNB beam-UE direction space. The measurement representation in the gNB beam-UE direction space may be input into the generic ML model for further processing. The network device 1001 may use the generic unit to provide 1090 a probability distribution in the output direction space. The probability distribution may indicate a probability of each direction in the direction space associated with the UE Set A of beams. Additionally, the probability distribution may indicate a probability of a gNB beam of gNB Set A being a target or optimal gNB beam. The output direction space may be also referred to as a gNB beam-UE direction space. The probability distribution of directions in the direction space associated with the UE Set A may be input into the post-processing unit for further processing.

The network device 1001 may use the post-processing unit to provide 1092 a probability distribution of UE beams in the UE Set A beam space. The network device 1001 may determine, based on the probability distribution of UE beams in the UE Set A beam space, a target UE beam from the UE Set A. In this way, the network device 1001 may select 1094, beam pair(s) with the highest probability (ies). The network device 1001 may transmit 1096 a beam index 1098 of the selected UE beam from the UE Set A to the terminal device 1002. The terminal device 1002 may receive 1099 the beam index 1098 and use the selected beam pair(s) for communication with the network device 1001.

FIG. 11 illustrates another example of the process 1100 for a DL Tx-Rx beam pair prediction according to an embodiment of the present disclosure. As illustrated in FIG. 11, a network device 1101 and a terminal device 1102 may be involved in the process 1100.

In the process 1100, a generic ML model may be trained at the network device 1101. The network device 1101 may transmit the trained ML model, e.g., architecture and parameters, to the terminal device 1102. The terminal device 1102 may use the trained ML model for inference. The terminal device 1102 may process beam measurements with beam pairs from the Set B in the beam codebook B (CB^{B}) and predict a beam pair or a list of beam pairs from the Set A in the beam codebook A (CB^{A}). In addition, in the process 1100, the pre-processing unit and the post-processing unit may be processed at the terminal device 1102.

Specifically, in the process 1100, the network device 1101 may select 1105 a desired NW or gNB Set B of beams. The NW Set B of beams may comprise wide beams or narrow beams for beam prediction. The network device 1101 may select 1110 hyper-parameters for the ML model, e.g., an input dimension and an output dimension. The network device 1101 may train 1115 the generic ML model based on the selected hyper-parameters.

The network device 1101 may transmit 1120 the hyper-parameters 1125 to the terminal device 1102. The terminal device 1102 may receive 1130 the hyper-parameters 1125. In some embodiments, the network device 1101 may select a pre-processing scheme and transmit the pre-processing scheme to the terminal device 1102. Alternatively, the terminal device 1102 may determine the pre-processing scheme rather than receiving it from the network device 1101.

The terminal device 1102 may select 1135 a desired UE Set B of beams for obtaining the beam measurements. The UE Set B may comprise wide beams or narrow beams. The terminal device 1102 may transmit 1140, to the network device 1101, capability information 1145 indicating capability of performing beam resource allocation prediction in a spatial domain without measuring all beams in a beam codebook. For example, the capability information 1145 may indicate that the terminal device 1102 is capable of performing DL Tx-Rx beam pair prediction by using a generic ML model.

The network device 1102 may receive 1150 the capability information 1145 and transmit 1155 ML model architecture and weights 1160 to the terminal device 1102. The ML model architecture may comprise a number of layers, layer size, etc. The terminal device 1102 may receive 1165 the ML model architecture and weights 1160, and re-construct the ML model that is already trained at the network device 1101.

The terminal device 1102 may perform 1170 beam measurements with the network device 1101. The beam measurements may be performed with NW Set B and UE Set B of beams, i.e., Set B of beam pairs. The beam measurements may comprise RSRP and/or CSI-RS measurements.

The terminal device 1102 may use the pre-processing unit to map 1180 the beam measurements with gNB Set B and UE Set B to measurement representation in a gNB beam (of Set B)—UE direction space associated with the UE Set B. The terminal device 1102 may use the generic unit to provide 1182 a probability distribution in a gNB beam (of Set A)—UE direction space associated with the UE Set A.

The terminal device 1102 may use the post-processing unit to provide 1184 a probability distribution of UE beams in the UE Set A beam space. The terminal device 1102 may determine, based on the probability distribution of UE beams in the UE Set A beam space, a target UE beam from the UE Set A. In this way, the terminal device 1102 may select 1188, beam pair(s) with the highest probability (ies). The terminal device 1102 may further transmit a beam index of the selected gNB beam to the network device 1101.

With reference to FIGS. 7 to 11, examples of processes of UE-agnostic beam selection and beam pair selection according to the present disclosure are described. Similar embodiments may be considered for gNB-agnostic_UE-specific beam (pair) selection. The ML model may be developed and trained at the UE. The UE codebook A and B may be fixed for different gNBs, thus the ML model may not need to be agnostic to the UE codebooks. In this case, the pre-processing unit may map the beam measurements to measurement representation in an input direction space associated with the gNB Set B. The forward mapping information for the gNB codebook B, antenna gain or a direction set associated with a beam of the gNB codebook B may be used in the pre-processing unit.

For example, the pre-processing unit may map the beam measurements to measurement representation in a UE beam (of Set B)—gNB direction space associated with the gNB Set B. The ML model may provide a probability distribution in a UE beam (of Set A)—gNB direction space associated with the gNB Set A. The post-processing unit may provide a probability distribution of gNB beams in the gNB Set A beam space. The target gNB beam from the gNB Set A may be determined based on the probability distribution of gNB beams in the gNB Set A beam space. Note that the pre-processing unit, the generic unit and/or the post-processing unit may be processed at the UE or gNB for inference.

Alternatively or additionally, similar embodiments may be considered for gNB-agnostic_UE-agnostic beam (pair) selection, where gNB has the capability to change its codebook based on changes in the environment, hardware imperfections, hardware update, codebook update, etc. The ML model may be developed and trained at the UE or gNB. In this case, the pre-processing unit may map the beam measurements to UE measurement representation in an input direction space associated with the UE Set B and to gNB measurement representation in an input direction space associated with the gNB Set B. The pre-processing unit may combine the UE measurement representation and the gNB measurement representation to obtain combined measurement representation in a UE Set B-gNB Set B direction space as an input to the ML model.

The ML model may provide a probability distribution in a UE Set A-gNB Set A direction space. The post-processing unit may provide a probability distribution of UE Set A-gNB Set A beam pairs in the Set A beam spaces. The target UE-gNB beam pair may be determined based on the probability distribution of UE Set A-gNB Set A beam pairs in the Set A beam spaces. Note that the pre-processing unit, the generic unit and/or the post-processing unit may be processed at the UE or gNB for inference.

With the solution according to the present disclosure, beam selection for different UE devices with different codebooks with a single ML model may be achieved. In addition, the device-agnostic framework may reduce the training data collection requirement, as training dataset can be collected from different devices and there may be no restriction of the UE codebook. Moreover, unseen devices in the training dataset can be served without any fine-tuning samples. The proposed framework 100 can make the model management easier, as only one generic ML model is used for all the UE devices and/or gNB codebooks.

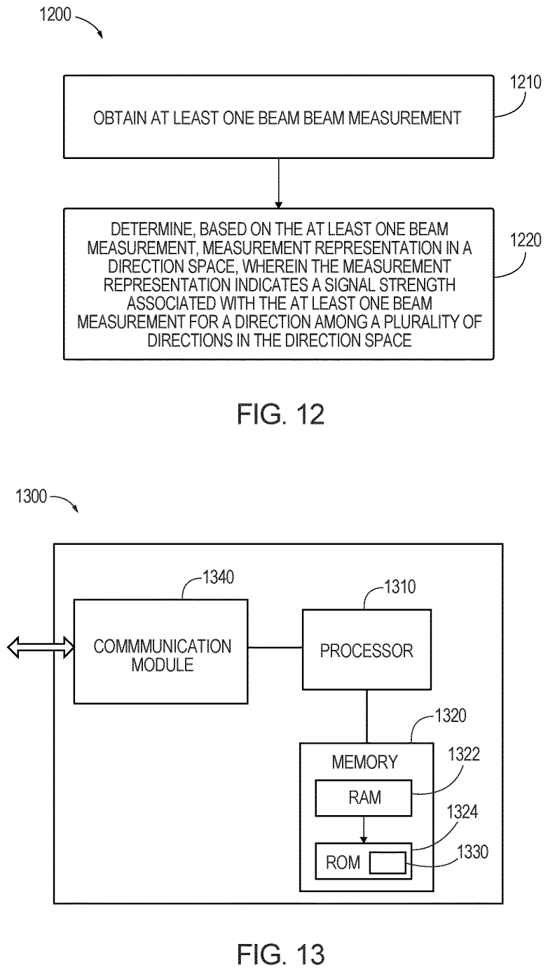

FIG. 12 illustrates a flowchart of an example method 1200 implemented at a device in accordance with some embodiments of the present disclosure. For the purpose of discussion, the method 1200 will be described from the perspective of the network device 181 and the terminal device 182 with reference to FIG. 1B.

At block 1210, a device obtains at least one beam measurement. At block 1220, the device further determines, based on the beam measurement(s), measurement representation in a direction space, wherein the measurement representation indicates a signal strength associated with the beam measurement(s) for a direction among a plurality of directions in the direction space.

In some embodiments, the at least one beam measurement may be associated with a first beam set, and the device may further perform at least one of the following: determining, based on the measurement representation in the direction space, at least one target beam from a second beam set, or transmitting, to a different device, the measurement representation in the direction space for determining at least one target beam from a second beam set, and wherein the first beam set and the second beam set are specific to a same terminal device.

In some embodiments, the device may determine the measurement representation by: obtaining forward mapping information, wherein the forward mapping information is associated with antenna gain, for a direction among the plurality of directions in the direction space, of a beam in the first beam set; and determining the signal strength for a direction among the plurality of directions based on the forward mapping information and the at least one beam measurement.

In some embodiments, the device may determine the signal strength for the direction among the plurality of directions based on one of the following: a beam measurement of a beam that provides the highest antenna gain among the first beam set, a distribution of the at least one beam measurement of the first beam set, or a distribution of a beam measurement of a beam that provides the highest antenna gain among the first beam set.

In some embodiments, the forward mapping information may indicate at least one of the following: antenna gain, for a direction among the plurality of directions in the direction space, of a beam in a first beam codebook, or a direction set associated with a beam in a first beam codebook, wherein the direction set comprises one or more directions in the direction space that are provided by the beam with the highest antenna gain among beams in the first beam codebook, wherein the first beam codebook comprises the first beam set.

In some embodiments, the direction space may be a first direction space for the first beam set, and the device may determine the at least one target beam from the second beam set by: determining, based on the measurement representation in the first direction space, a probability distribution for a second plurality of directions in a second direction space for the second beam set; and determining, based on the probability distribution, the at least one target beam from the second beam set.

In some embodiments, the device may determine the probability distribution for the second plurality of directions in the second direction space by: using a unit that maps information from the first direction space to the second direction space.

In some embodiments, the device may determine, based on the probability distribution, the at least one target beam from the second beam set by: obtaining backward mapping information, wherein the backward mapping information is associated with antenna gain, for a direction of the second plurality of directions in the second direction space, of a beam in the second beam set; determining, based on the backward mapping information and the probability distribution for the second plurality of directions, a beam probability distribution for the second beam set; and determining the at least one target beam from the second beam set based on the beam probability distribution for the second beam set.

In some embodiments, the backward mapping information may indicate at least one of the following: antenna gain, for a direction of the second plurality of directions in the second direction space, of a beam in a second beam codebook, or a second direction set associated with a beam in a second beam codebook, wherein the second direction set comprises one or more directions in the second direction space that are provided by the beam with the highest antenna gain among the second beam codebook, wherein the second beam codebook comprises the second beam set.

In some embodiments, the first beam set may comprise a first plurality of beam pairs and the second beam set may comprise a second plurality of beam pairs, and wherein the device may determine the at least one target beam from the second beam set by: determining at least one beam pair from the second plurality of beam pairs, wherein a beam pair among the at least one beam pair comprises a transmit beam and a corresponding receive beam.

In some embodiments, the first beam set and the second beam set are the same, the first beam set is a subset of the second beam set, or the first beam set comprises wider beams and the second beam set comprises narrower beams.

In some embodiments, the direction space may be defined by a grid and a point of the grid may represent a direction among the plurality of directions in the direction space.

In some embodiments, the at least one beam measurement may comprises at least one of reference signal received power, RSRP, measurements and received signal strength, RSS, measurements.

In some embodiments, the device may be the terminal device 182 and the terminal device 182 may further receive, from a network device, the unit with an input dimension and an output dimension; and determine a size of the first beam set and a size of the second beam set based on the input dimension and the output dimension.

In some embodiments, the terminal device 182 may further transmit, to the network device, at least one of the following: capability information indicating a capability of performing resource allocation in a spatial domain without a beam codebook, input dimension information indicating at least one supported input dimensions, or output dimension information indicating at least one supported output dimensions.

In some embodiments, the device may be the network device 181 and the network device 181 may further receive, from a terminal device, the forward mapping information for the terminal device. In some embodiments, the network device 181 may further develop the unit with an input dimension and an output dimension; and transmit, to the terminal device, the input dimension and the output dimension. The unit may comprise a machine learning model generic to terminal devices or beam codebooks.

In some embodiments, an apparatus capable of performing any of the method 1200 (for example, the network device 181 or the terminal device 182, 183) may comprise means for performing the respective steps of the method 1200. The means may be implemented in any suitable form. For example, the means may be implemented in a circuitry or software module.

In some embodiments, the apparatus comprises: means for obtaining at least one beam measurement; and means for determining, based on the at least one beam measurement, a measurement representation in a direction space, wherein the measurement representation indicates a signal strength associated with the at least one beam measurement for a direction among a plurality of directions in the direction space.

In some embodiments, the at least one beam measurement may be associated with a first beam set, and the apparatus may further comprise means for performing at least one of the following: determining, based on the measurement representation in the direction space, at least one target beam from a second beam set, or transmitting, to a different device, the measurement representation in the direction space for determining at least one target beam from a second beam set, and wherein the first beam set and the second beam set are specific to a same terminal device.

In some embodiments, the means for determining the measurement representation may comprise: means for obtaining forward mapping information, wherein the forward mapping information is associated with antenna gain, for a direction among the plurality of directions in the direction space, of a beam in the first beam set; and means for determining the signal strength for a direction among the plurality of directions based on the forward mapping information and the at least one beam measurement.

In some embodiments, the means for determining the signal strength for the direction among the plurality of directions may be based on one of the following: a beam measurement of a beam that provides the highest antenna gain among the first beam set, a distribution of the at least one beam measurement of the first beam set, or a distribution of a beam measurement of a beam that provides the highest antenna gain among the first beam set.

In some embodiments, the forward mapping information may indicate at least one of the following: antenna gain, for a direction among the plurality of directions in the direction space, of a beam in a first beam codebook, or a direction set associated with a beam in a first beam codebook, wherein the direction set comprises one or more directions in the direction space that are provided by the beam with the highest antenna gain among beams in the first beam codebook, wherein the first beam codebook comprises the first beam set.

In some embodiments, the direction space may be a first direction space for the first beam set, and the means for determining the at least one target beam from the second beam set may comprise: means for determining, based on the measurement representation in the first direction space, a probability distribution for a second plurality of directions in a second direction space for the second beam set; and means for determining, based on the probability distribution, the at least one target beam from the second beam set.

In some embodiments, the means for determining the probability distribution for the second plurality of directions in the second direction space may comprise: means for using a unit that maps information from the first direction space to the second direction space.

In some embodiments, the means for determining, based on the probability distribution, the at least one target beam from the second beam set may comprise: means for obtaining backward mapping information, wherein the backward mapping information is associated with antenna gain, for a direction of the second plurality of directions in the second direction space, of a beam in the second beam set; means for determining, based on the backward mapping information and the probability distribution for the second plurality of directions, a beam probability distribution for the second beam set; and means for determining the at least one target beam from the second beam set based on the beam probability distribution for the second beam set.

In some embodiments, the backward mapping information may indicate at least one of the following: antenna gain, for a direction of the second plurality of directions in the second direction space, of a beam in a second beam codebook, or a second direction set associated with a beam in a second beam codebook, wherein the second direction set comprises one or more directions in the second direction space that are provided by the beam with the highest antenna gain among the second beam codebook, wherein the second beam codebook comprises the second beam set.

In some embodiments, the first beam set may comprise a first plurality of beam pairs and the second beam set may comprise a second plurality of beam pairs, and wherein the means for determining the at least one target beam from the second beam set may comprise means for: determining at least one beam pair from the second plurality of beam pairs, wherein a beam pair among the at least one beam pair comprises a transmit beam and a corresponding receive beam.

In some embodiments, the first beam set and the second beam set may be the same, the first beam set may be a subset of the second beam set, or the first beam set may comprise wider beams and the second beam set may comprise narrower beams.

In some embodiments, the direction space may be defined by a grid and a point of the grid may represent a direction among the plurality of directions in the direction space.

In some embodiments, the at least one beam measurement may comprises at least one of reference signal received power, RSRP, measurements and received signal strength, RSS, measurements.

In some embodiments, the apparatus may be the terminal device 182 and the apparatus may further comprise: means for receiving, from a network device, the unit with an input dimension and an output dimension; and means for determine a size of the first beam set and a size of the second beam set based on the input dimension and the output dimension.

In some embodiments, the apparatus may further comprise: means for transmitting, to the network device, at least one of the following: capability information indicating a capability of performing resource allocation in a spatial domain without a beam codebook, input dimension information indicating at least one supported input dimensions, or output dimension information indicating at least one supported output dimensions.

In some embodiments, the apparatus may be the network device 181 and the apparatus may further comprise: means for receiving, from a terminal device, the forward mapping information for the terminal device. In some embodiments, the apparatus may further comprise: means for developing the unit with an input dimension and an output dimension; and means for transmitting, to the terminal device, the input dimension and the output dimension. The unit may comprise a machine learning model generic to terminal devices or beam codebooks.

In some embodiments, the apparatus further comprises means for performing other steps in some embodiments of the method 1200. In some embodiments, the means comprises at least one processor and at least one memory including computer program code, the at least one memory and computer program code configured to, with the at least one processor, cause the performance of the apparatus.

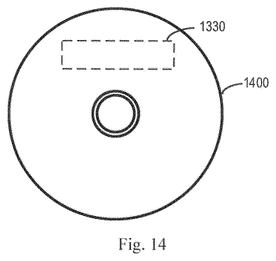

FIG. 13 is a simplified block diagram of a device 1300 that is suitable for implementing embodiments of the present disclosure. The device 1300 may be provided to implement the communication device, for example the terminal device 182 and the network device 181 as shown in FIG. 1B. As shown, the device 1300 includes one or more processors 1310, one or more memories 1340 coupled to the processor 1310, and one or more communication modules 1340 coupled to the processor 1310.

The communication module 1340 is for bidirectional communications. The communication module 1340 has at least one antenna to facilitate communication. The communication interface may represent any interface that is necessary for communication with other network elements.

The processor 1310 may be of any type suitable to the local technical network and may include one or more of the following: general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

The memory 1320 may include one or more non-volatile memories and one or more volatile memories. Examples of the non-volatile memories include, but are not limited to, a Read Only Memory (ROM) 1324, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1322 and other volatile memories that will not last in the power-down duration.

A computer program 1330 includes computer executable instructions that are executed by the associated processor 1310. The program 1330 may be stored in the ROM 1324. The processor 1310 may perform any suitable actions and processing by loading the program 1330 into the RAM 1322.

The embodiments of the present disclosure may be implemented by means of the program 1330 so that the device 1300 may perform any process of the disclosure as discussed with reference to FIGS. 2 to 12. The embodiments of the present disclosure may also be implemented by hardware or by a combination of software and hardware.

In some embodiments, the program 1330 may be tangibly contained in a computer readable medium which may be included in the device 1300 (such as in the memory 1320) or other storage devices that are accessible by the device 1300. The device 1300 may load the program 1330 from the computer readable medium to the RAM 1322 for execution. The computer readable medium may include any types of tangible non-volatile storage, such as ROM, EPROM, a flash memory, a hard disk, CD, DVD, and the like. FIG. 14 shows an example of the computer readable medium 1400 in form of CD or DVD. The computer readable medium has the program 1330 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 or 700 as described above with reference to FIGS. 2-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-21. (canceled)

22. A device comprising:
at least one processor; and
at least one memory storing instructions that, when executed by the at least one processor, cause the device at least to:
obtain at least one beam measurement; and
determine, based on the at least one beam measurement, a measurement representation in a configurable direction space, wherein the measurement representation indicates a signal strength associated with the at least one beam measurement for a direction among a plurality of directions in the direction space.

23. The device of claim 22, wherein the at least one beam measurement is associated with a first beam set, and the device is further caused to perform at least one of the following:
determining, based on the measurement representation in the direction space, at least one target beam from a second beam set, or
transmitting, to a different device, the measurement representation in the direction space for determining at least one target beam from a second beam set, and
wherein the first beam set and the second beam set are specific to a same terminal device or a same network device.

24. The device of claim 23, wherein the device is caused to determine the measurement representation by:
obtaining forward mapping information, wherein the forward mapping information is associated with antenna gain, for a direction among the plurality of directions in the direction space, of a beam in the first beam set; and
determining the signal strength for a direction among the plurality of directions based on the forward mapping information and the at least one beam measurement.

25. The device of claim 24, wherein the device is caused to determine the signal strength for the direction among the plurality of directions based on one of the following:
a beam measurement of a beam that provides the highest antenna gain among the first beam set,
a distribution of the at least one beam measurement of the first beam set, or
a distribution of a beam measurement of a beam that provides the highest antenna gain among the first beam set.

26. The device of claim 24, wherein the forward mapping information indicates at least one of the following:
antenna gain, for a direction among the plurality of directions in the direction space, of a beam in a first beam codebook, or
a direction set associated with a beam in a first beam codebook, wherein the direction set comprises one or more directions in the direction space that are provided by the beam with the highest antenna gain among beams in the first beam codebook,
wherein the first beam codebook comprises the first beam set.

27. The device of claim 23, wherein the direction space is a first direction space for the first beam set, and wherein the device is caused to determine the at least one target beam from the second beam set by:
determining, based on the measurement representation in the first direction space, a probability distribution for a second plurality of directions in a second direction space for the second beam set; and
determining, based on the probability distribution, the at least one target beam from the second beam set.

28. The device of claim 27, wherein the device is caused to determine the probability distribution for the second plurality of directions in the second direction space by:
using a unit that maps information from the first direction space to the second direction space.

29. The device of claim 28, wherein the device is a network device and the network device is further caused to:
develop the unit with an input dimension and an output dimension; and
transmit, to the terminal device, the input dimension and the output dimension.

30. The device of claim 29, wherein the unit comprises a machine learning model generic to terminal devices or beam codebooks.

31. The device of claim 27, wherein the device is caused to determine, based on the probability distribution, the at least one target beam from the second beam set by:
obtaining backward mapping information, wherein the backward mapping information is associated with antenna gain, for a direction of the second plurality of directions in the second direction space, of a beam in the second beam set;
determining, based on the backward mapping information and the probability distribution for the second plurality of directions, a beam probability distribution for the second beam set; and
determining the at least one target beam from the second beam set based on the beam probability distribution for the second beam set.

32. The device of claim 31, wherein the backward mapping information indicates at least one of the following:
antenna gain, for a direction of the second plurality of directions in the second direction space, of a beam in a second beam codebook, or
a second direction set associated with a beam in a second beam codebook, wherein the second direction set comprises one or more directions in the second direction space that are provided by the beam with the highest antenna gain among the second beam codebook,
wherein the second beam codebook comprises the second beam set.

33. The device of claim 23, wherein the first beam set comprises a first plurality of beam pairs and the second beam set comprises a second plurality of beam pairs, and wherein the device is caused to determine the at least one target beam from the second beam set by:
determining at least one beam pair from the second plurality of beam pairs, wherein a beam pair among the at least one beam pair comprises a transmit beam and a corresponding receive beam.

34. The device of claim 23, wherein:
the first beam set is a subset of the second beam set, or
the first beam set comprises wider beams and the second beam set comprises narrower beams.

35. The device of claim 23, wherein the device is a terminal device and the terminal device is further caused to:
receive, from a network device, an input dimension and an output dimension; and
determine a size of the first beam set and a size of the second beam set based on the input dimension and the output dimension.

36. The device of claim 35, wherein the terminal device is further caused to transmit, to the network device, at least one of the following:
capability information indicating a capability of performing resource allocation in a spatial domain without a beam codebook,
input dimension information indicating at least one supported input dimensions, or
output dimension information indicating at least one supported output dimensions.

37. The device of claim 22, wherein the direction space is defined by a grid and a point of the grid represents a direction among the plurality of directions in the direction space.

38. The device of claim 22, wherein the at least one beam measurement comprises at least one of reference signal received power measurements and received signal strength measurements.

39. A method comprising:
obtaining at least one beam measurement; and
determining, based on the at least one beam measurement, a measurement representation in a configurable direction space, wherein the measurement representation indicates a signal strength associated with the at least one beam measurement for a direction among a plurality of directions in the direction space.

40. A computer readable program product comprising instructions, which when executed by an apparatus, cause the apparatus at least to:
obtain at least one beam measurement; and
determine, based on the at least one beam measurement, a measurement representation in a configurable direction space, wherein the measurement representation indicates a signal strength associated with the at least one beam measurement for a direction among a plurality of directions in the direction space.
